(19) United States
(12) Patent Application Publication
(10) Pub. No.: US 2026/0118476 A1
(43) Pub. Date: Apr. 30, 2026

(54) COMPUTER-IMPLEMENTED METHOD FOR MACHINE LEARNING OF DENOISING OF DATA IN A RADAR DATA PROCESSING PROCESS, RADAR DATA PROCESSING METHOD, COMPUTER PROGRAM FOR RADAR DATA PROCESSING, RADAR SENSOR FOR ENVIRONMENT SENSING FOR A VEHICLE

(71) Applicant: ZF Friedrichshafen AG, Friedrichshafen (DE)

(72) Inventors: Georg Schneider, Urbar (DE); Stephan Weigand, Saarbrücken (DE); Christian Seiffer, St. Ingbert (DE)

(73) Assignee: ZF Friedrichshafen AG, Friedrichshafen (DE)

(21) Appl. No.: 19/163,729

(22) PCT Filed: Mar. 1, 2024
(86) PCT No.: PCT/EP2024/055355

§ 371 Date: Sep. 9, 2025

(30) Foreign Application Priority Data
Mar. 9, 2023 (DE) 10 2023 202 091.2

(51) Int. Cl. G01S 7/40; G06N 3/0455

(52) U.S. Cl. CPC G01S 7/40; G06N 3/0455

(57) ABSTRACT

A computer-implemented method for removing noise from data through machine learning in radar data processing, comprising the following steps: generating training data in at least one step in the radar data processing by recording predefined scenarios with at least one reference radar sensor, wherein there is less noise in the training data than in field data obtained in field recordings made with a field radar sensor, processing the training data in a forward diffusion process in a diffusion model, and processing the noisy training data in a reverse diffusion process in the diffusion model, wherein the machine learning model generates denoised data from the noisy data obtained from the radar data processing after the learning phase.

### CROSS-REFERENCE TO RELATED APPLICATIONS

This application is a U.S. national stage application under 35 U.S.C. § 371 of PCT Application No. PCT/EP2024/055355, filed on Mar. 1, 2024, and published as WO 2024/184223 A1 on Sep. 12, 2024, which claims priority from German Application No. DE 10 2023 202 091.2, filed on Mar. 9, 2023, the entirety of which are each hereby fully incorporated by reference herein.

### FIELD

The present disclosure relates to a computer-implemented method for teaching a machine how to remove noise in radar data. The present disclosure also relates to a method for processing radar data. The present disclosure also relates to a radar data processing program. The present disclosure also relates to a radar sensor for recording a vehicle's environment.

The following definitions, descriptions, and explanations apply to everything disclosed herein relating to the present disclosure.

### BACKGROUND

Radar sensors are used in the automotive industry for advanced driver assistance systems (ADAS), e.g. a collision avoidance system. When used in highly automated or autonomous vehicles, radar sensors must also suppress secondary radar beams, to obtain elevation information and good angular resolution along the azimuth and altitude. Existing imaging radar architectures, e.g. 4D imaging radar, satisfy the requirements regarding elevation information and angular resolution. Nevertheless, real redundancy for lidar sensor systems such as those used for automated driving (AD) has not yet been achieved in the prior art because the point clouds obtained with radar have insufficient density.

The resolution obtained with existing radar sensors is not as good as that with optical sensors such as cameras and lidar systems. Radar resolution is a function of the number of transmitting and/or receiving antennas, which is limited by the available installation space. Angular resolution in particular is a decisive quality criterion.

The resolution obtained with radar depends on the signal processing chain. Data complexity is reduced a number of times in the radar signal processing chain, thus reducing the data content incrementally. A negative side effect is the risk of failing to take relevant information into account. This “relevance” refers to the later use of such data in the signal processing chain that would result in higher quality data. At this point, it makes sense to use artificial intelligence methods, because they can determine the significance of data for further processing.

There are numerous artificial intelligence approaches for learning this. One of these is using information from less complex data to generate data of higher quality. For radar signal processing, this relates to removing noise from the signals.

The software used in the prior art is a limiting factor with regard to exploiting the full potential of radar sensors.

### SUMMARY

A fundamental object of the present disclosure is to increase the quality of the signal processing in the radar signal chain, in particular increasing the output quality for detected targets or objects. Higher quality involves increasing the maximum resolution, better separation of adjacent targets or objects, better delineation of objects or targets from background noise in the sensor system, reducing the effects of multiple paths, and detecting objects that reflect weakly.

The subject matter disclosed herein solves these problems. Advantageous embodiments of the present disclosure can be derived from the definitions, drawings, and descriptions of preferred exemplary embodiments.

One aspect of the present disclosure is a computer-implemented method for teaching a machine to remove noise from radar data.

Radar data processing, or signal processing, is explained in J. Fuchs et al., Machine Learning Perspective on Automotive Radar Direction of Arrival Estimation, IEEEAccess, Volume 10, 2022, p. 6776-6780 and Y. Zhou et al., Towards Deep Radar Perception for Autonomous Driving: Datasets, Methods, and Challenges, Sensors 2022, 1, 0. The radar data processing steps disclosed therein belong to this patent application by way of the above explicit reference thereto. In general, an object detected by radar comprises numerous reflection points, or targets. The radar outputs a list of targets in each data processing cycle.

The radar sensor can be a chirp-sequence frequency-modulated continuous-wave radar (FM-CW radar). This radar sensor can be a system on a chip, in which the transmitting and receiving antennas, as well as the evaluation electronics for the radar data processing are integrated in a chip.

The method can be implemented in each step of the radar data processing, e.g. as an independent piece of software code, or as a hardware component that executes the method. A ground tooth sensor can be obtained with the method with which a higher value output is obtained, not in real time, that can then be used for validation. This can be calculated in an external computing cluster in the cloud, or in an internal computing center belonging to the company.

The method comprises a step for generating training data in at least one step in the radar data processing by recording predefined scenarios with at least one reference radar sensor. There is less noise in the training data obtained with the reference radar sensor in predefined scenarios than in data obtained with a radar sensor used to record data in the field.

Training data are of better quality than that initially obtained with a radar sensor in the field. Correct generation of this data is decisive for the quality of the machine learning model.

The predefined scenarios contain as little disruptions as possible with regard to radar detection. This minimizes noise in the training data.

The reference radar sensor has better resolution and higher value materials than the field radar sensor. The reference radar sensor is used for training, validation, or testing the machine learning model. The field radar sensor is the sensor used in an automated driving system to detect objects outside the vehicle.

Recording a scenario with a radar sensor involves transmitting radar waves and receiving radar waves reflected by targets, which are then evaluated in a method for radar data processing.

Noise is the result of limited resolution, poor separation of adjacent targets, the effects of multiple paths between the radar sensor and the targets, as well noises in the electronics. Temporal limitations of signal processing may also result in noise. If, for example, a radar cycle lasts 60 ms, i.e. the radar transmits data every 60 milliseconds, part of this is physically required for transmitting and receiving signals, while the rest remains available for signal processing. It is impossible to reduce resulting noise and imprecision due to limited resources.

In another step in the method, the training data are processed in a forward diffusion process in a diffusion model. The forward diffusion process contains a set number of diffusion steps. Noisy training data is obtained by adding noise in iterations or incrementally.

Diffusion models are disclosed in arXiv:2209.04747v3 [cs.CV] Dec. 20 2022, Chapter 2, and belong to the scope of this patent application by way of this explicit reference thereto. In general, diffusion models are a class of probabilistic models that learn to reverse a process in which the structure of the training data progressively worsens.

The training method has two phases: the forward diffusion process and the reverse diffusion process, also referred to as the noise removal process.

The first phase has numerous steps, in which low noises are added to each sample in the training data, the levels of which can vary in each step. The training data are destroyed incrementally, until pure noise is obtained.

The last phase involves reversing the forward diffusion process. It is similar to the forward iterative process, but in reverse. Incremental removal of noise is learned, thus restoring the original sample from the training data.

The diffusion model can be a denoising diffusion probabilistic model (DDPM) like that disclosed in Chapter 2.1 of arXiv:2209.04747v3 [cs.CV] Dec. 20, 2022.

The noisy training data that are obtained are then processed in another step in a reverse diffusion process in the diffusion model. At least one machine learning model receives a data sample input from the training data in a preceding step in the diffusion process during the reverse diffusion process steps. The machine learning model learns to subtract the respective noise and output a data sample of training data from which noise has been removed during the training.

This noisy data is therefore data from intermediate steps in the radar data processing. It is possible to determine which data is without noise from this, which is key in the creation of the system. Data is then generated that corresponds to the intermediate stages between data with and without noise.

By way of example, the noisy data is obtained in the forward diffusion process through a Markov chain that has a normal distribution with a given expected value and given variation. The machine learning model is trained to estimate the expected value and variation from noisy training data. The machine learning model is also trained to determine the noise portion directly from the noisy training data. The original, noiseless training data are then restored in the reverse diffusion process.

The machine learning model is an artificial neural network, e.g. a convolutional neural network. The artificial neural network comprises layers, or the entire architecture of the U-net disclosed in arXiv: 1505.04597 [cs.CV], for example.

After the learning phase, the machine learning model obtains denoised data from noisy data in the radar data processing.

A reversing function is therefore learned that is used in the field after the training process, for removing noise from radar data with the trained machine learning model through inference. It is therefore possible to obtain an output in the format of the input data and, with additional steps, an output corresponding to the formats of later steps in the radar data processing.

Noise can be removed from radar data with the trained machine learning model at various points in the radar data processing, e.g. in earlier stages in which the data are in a frequency range obtained with a fast Fourier transformation, as well as in later steps, in which the data are already at the target level, i.e. in the form of a point cloud. By incorporating this directly in the radar data processing, the radar data are processed in real time, without delaying the radar cycles.

This removal of noise from radar data with a machine learning model improves the output quality for targets detected using radar sensors. Higher quality means that the maximum resolution is improved, there is better separation of adjacent targets and objects, there is better delineation of objects and targets from background noise, the effects of multiple paths are reduced, objects that reflect poorly are detected, etc.

Highly reflective targets are placed at specific positions in predefined scenarios within the range of the radar sensors in another aspect of the present disclosure. By way of example, highly reflective targets are purposely placed according to testing protocols, under appropriate laboratory conditions, e.g. without external disruptions. The noise in the training data recorded by the reference radar sensor in these types of scenarios is then extremely minimized.

These scenarios are reproductions of street traffic in which disruptions are minimized along a test track. This test track has no guardrails, bridges, or other objects that could disrupt radar detection. This minimizes the disruptions, resulting in scenarios with very little noise.

The predefined scenarios can also be recorded by reference radar sensors placed at different distances to the targets. Consequently, data from the same scenario available for a radar sensor that is further away are available for a closer radar sensor, which can later be projected at a further distance while retaining the high quality of the information. This raises the quality of the training data.

The reference radar sensor has better hardware components than the field radar sensor. The recordings can be obtained using a better radar sensor that exhibits minimal material fluctuations or has better individual components for specific uses. Consequently, the best components can be used, which would be too expensive for mass production, but are ideal for this. This raises the quality of the training data.

The reference radar sensor in another version is a radar sensor model, and the predefined scenarios are simulated. Radar simulation generates data for specific scenarios, as well as synthetically obtaining or reproducing data on the basis of a fundamental data set. The scenarios can also be observed over a longer period of time in order to remove disruptions at individual points in time with information from the future and/or past. This raises the quality of the training data.

Data can also be preprocessed at a high level. As a result of the replacement of one or more steps in the radar data processing enabled by the present disclosure with more effective algorithms or processes, which may require more resources or more processing time and are thus no longer able to provide outputs in real time, it is possible to obtain a better output using the same raw data.

The radar data processing can also include a step in which the data undergo a distance Fourier transformation, which delivers information regarding the distance to the target. The data obtained from the distance Fourier transformation can be the input data that are processed by the diffusion model as training data. This distance Fourier transformation can be a fast Fourier transformation or a discrete Fourier transformation.

The radar data processing can also include a doppler Fourier transformation of the data, which delivers information regarding the speed of the target. The data obtained from the doppler Fourier transformation can be the input data that are processed by the diffusion model as training data. This doppler Fourier transformation can be a fast Fourier transformation or a discrete Fourier transformation.

The radar data processing can also include an angular Fourier transformation of the data, which delivers information regarding the angle to the target. The data obtained from the angular Fourier transformation can be the input data that are processed by the diffusion model as training data. This angular Fourier transformation can be a fast Fourier transformation or a discrete Fourier transformation.

The radar data processing can also include a constant false alarm rate algorithm (CFAR) for identifying the targets. The data obtained from the CFAR algorithm can be the input data that are processed by the diffusion model as training data.

The radar data processing can also include a cluster algorithm to obtain a cluster analysis of the targets, e.g. density-based spatial clustering of applications with noise (DBSCAN) algorithm. Numerous targets are combined by clustering to obtain objects. By way of example, numerous targets can be assigned to a vehicle. The data obtained from the clustering algorithm can be the input data that are processed by the diffusion model as training data.

The radar data processing can also include a tracking algorithm for tracking the targets. The data obtained from the tracking algorithm can be the input data that are processed by the diffusion model as training data.

The radar data processing can also include function determination. A driving function can be determined by evaluating radar data, e.g. emergency braking, which can be sent to a vehicle interface to execute the function.

The data obtained from a combination of the above steps can also be processed by the diffusion model.

The data formats for range/azimuth matrices obtained from the distance Fourier transformation and subsequent angular Fourier transformation, range/doppler matrices obtained from the distance Fourier transformation and subsequent doppler Fourier transformation, range/azimuth/doppler matrices obtained from the sequential distance Fourier transformation, doppler Fourier transformation, and angular Fourier transformation, or point clouds obtained from the constant false alarm rate algorithm, are processed by the diffusion model.

The above data formats form the input data formats. The same format as that selected for the input data can be selected for the output data format. The denoising of radar data by the machine learning model trained in the manner describe above can be inserted as an intermediate step in the radar data processing. Other formats, e.g. from later steps in the radar data processing, can also be selected, in order to skip over individual “traditional” steps in the signal processing. This takes place in additional downstream layers in the machine learning model to obtain the desired output format.

After the reverse diffusion process, the training data are in the format in which they were input for the forward diffusion process, or in another format.

The noise portions can be distributed normally. They can also be simulated, e.g. based on physical properties or taking radar specifications into account. The noise portions can also be generated using different hardware components or settings. Different qualities of the outputs can be obtained using different hardware components or settings, which then correspond to the different levels of the noisy data in combination with one or more of the above possibilities. One combination could be different hardware with Gaussian noise.

Simulation and different hardware are alternatives to Gaussian noise for obtaining equivalent effects. The selection is based on the evaluation regarding where the best results can be obtained in the radar for specific functions and objects.

Additional noise levels can also be generated. If, for example, six levels x1, . . . , x6 are desired, and x0 represents the original data, levels x2 and x4 can be represented with different hardware, while the other levels x1, x3, x5, x6 are generated through interpolation or Gaussian noise.

The training data can also be compressed through encoding. The encoded training data are processed by the diffusion model. The results from the reverse diffusion process are then decoded. By way of example, an encoder can be placed upstream of the machine learning model, and a decoder can be placed downstream. The encoder transforms the training data in a latent feature space, the machine learning model executes the diffusion process in the latent feature space, and the decoder transforms the outputs from the machine learning model back into the space for the original training data. The diffusion process is therefore learned either directly on the input format or after transformation in a latent space. Noises can be introduced into the latent feature space.

The latent space can be a pixel-based space, such that certain information is encoded into an imaging format. An example of this is transformation from fast Fourier transformation spectra, point clouds, grid maps, etc. into pixel-based images. The compression can also comprise direct transformation from a domain-specific space to a latent space. The encoder and decoder can also be machine learning models, e.g. artificial neural networks. By way of example, the encoding can take place using point-based models, e.g. graphic neural networks. In this case, all of the points in a point cloud are encoded into a graph, thus plotting them as nodes. The relationships between adjacent nodes then form edges in the graphs. Encoding and decoding can take place using variational autoencoders or generative adversarial networks.

The machine learning model can be used in all of the steps of the reverse diffusion process, or different machine learning models can be used in the steps of the reverse diffusion process.

Another aspect of the present disclosure relates to a method for radar data processing. Radar data are obtained from a radar sensor. Noise is removed from this radar data by a machine learning model trained with the above method in an intermediate step in the radar data processing. This denoised radar data is then input in a subsequent intermediate step in the radar data processing. This method results in a radar with higher quality outputs for detected targets or objects. This method can also be carried out on a central computer, instead of on the radar hardware. This makes greater computing capacity available, and potential savings can be realized with regard to the radar hardware.

The radar data processing method and hardware components that execute the method are referred to as AI denoising, or AI denoised radar (AIDR). AI stands for artificial intelligence.

The radar data processing method can be coupled to a dynamic situation and function-based radar system. The dynamic situation and function-based radar system is based on a computer-implemented method comprising the following steps:
receiving at least one first data radar set for an environment recorded with at least one radar sensor, and at least one first sensor data set for an environment recorded with at least one sensor;
determining at least one first actual scenario of the environment based on the first sensor data set using selection AI, i.e. artificial intelligence;
determining a radar function data set for an interface, in particular a vehicle interface, based on the first radar data set, the first actual scenario, and numerous predetermined processing steps that can be executed on the radar data set;
accessing numerous AI models for numerous environment scenarios, in which each of the numerous AI models are designed to replace at least on processing step in a respective scenario;
replacing at least one of the processing steps in the radar function data set with at least one first AI model using the selection AI when the first actual scenario conforms to at least one scenario in the AI model with a conformity value that is equal to or greater than a predetermined first conformity value;
determining the radar function data set based on the numerous predetermined processing steps or an adjusted number of processing steps when the at least one processing step has been replaced by the first AI model,
wherein the denoising takes place in an intermediate step in the above steps in the radar data processing.

Consequently, the individual AI models can be trained specifically for one or more scenarios and one or more processing steps. This results in a dynamic scenario-based method, representing a novel component for use in the radar signal processing chain with the purpose of improving the quality, e.g. by obtaining a maximum resolution, separating adjacent targets/objects, reducing the effects of multiple paths, and improving the outputs of detected targets/objects using the AI model. This reduces costs and increases safety and convenience. The key is the dynamic selection from a series of AI models that have been trained specifically for different scenarios.

The selection AI selects the AI models based on a comparison of the detected actual scenario with the scenarios in the AI models. The AI models are used to significantly improve the outputs from the radar signal processing chain for the actual scenario by executing at least some of the processing steps with one or more AI models. If none of the AI models depict a comparable scenario, the predetermined processing step, in particular classic signal processing, can be used. This results in new possibilities for the radar signal processing chain. Accordingly, individual steps in the classic processing chain can be replaced by AI models that can better execute the corresponding task based on defined input and output data. This can involve the integration of numerous AI models that are designed specifically for different tasks in the signal processing.

Another aspect of the present disclosure is a computer program for radar data processing. The computer program contains commands with which a hardware component carries out the radar data processing when the program is installed on the hardware or executed by it.

The computer program can contain interpretable code that is uploaded to the computer, e.g. directly on an internal drive, or provided as compiled code executed by the computer. Operations for interpreting the program are executed in an interpreter when running the program. The interpreter is another program that can enforce higher-order safety guidelines while the program disclosed herein is running. In the case of compilation, a program in a source language is translated to a program that is identical in many regards in a different language. It can be provided on a machine-readable medium that the computer program is stored on, e.g. a non-volatile storage medium, or it can take place via a data-carrier signal. The commands can be machine commands, source code, or object codes, written in assembly language, an object-oriented program language, e.g. C++, or a procedural programing language, e.g. C.

Another aspect of the present disclosure is a radar sensor for detecting a vehicle's environment. The radar sensor contains hardware designed to upload or run the computer program described above and remove the noise from radar data recorded by the radar sensor. By improving the output quality with the radar data denoising disclosed herein, using the trained machine learning model disclosed herein, the hardware can be developed relatively inexpensively.

The present disclosure is explained in greater detail in reference to the drawings of exemplary embodiments.

### BRIEF DESCRIPTION OF THE DRAWINGS

FIG. 1 shows an exemplary embodiment of AI denoising disclosed herein;

FIG. 2 shows an exemplary embodiment of a radar data processing method;

FIG. 3 shows a schematic illustration of the functioning of the diffusion model;

FIG. 4 shows a schematic illustration of the functioning of the diffusion model in a latent space; and

FIG. 5 shows an exemplary embodiment of an AI denoised radar system disclosed herein.

### DETAILED DESCRIPTION

Identical or functionally similar components have the same reference symbols in the drawings. For purposes of clarity, only those parts that are relevant have reference symbols in the drawings.

Input data x are input in the radar data denoising.

Input data x are generated in step V1 as training data in the training process by recording predefined scenarios with at least one reference radar sensor, in which there is less noise than in field data obtained from field recordings with a field radar sensor.

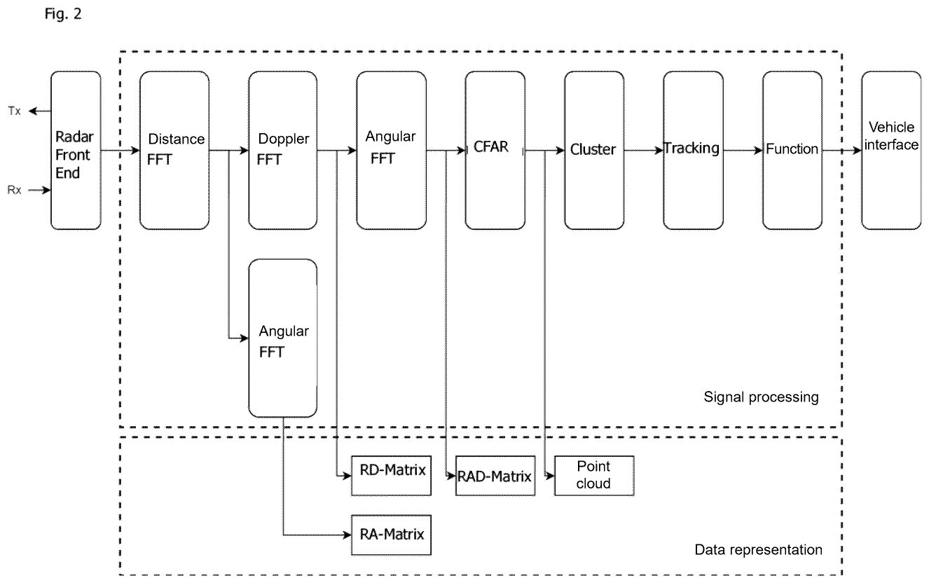

The input data x come from an arbitrary step in the radar data processing shown in FIG. 2 in a format such as a range/doppler matrix. The input data x is noisy. The machine learning model, also referred to as a denoising model, is trained in a diffusion model to detect noise R in the input data and generate output data x that no longer contains the noise R. The format for the output data can be the same as for the input data x, e.g. a range/doppler matrix. The machine learning model can also reverse the process. There is also an optional encoder E in the drawing that encodes the input data in a latent space, and a decoder D that returns the data in the latent space to the original space.

FIG. 2 illustrates a typical radar signal processing chain. There are transmitting antennas Tx and receiving antennas Rx at the front end of the radar. The raw data obtained with the radar, e.g. data or signals from receiving antennas Rx, are converted by means of distance, doppler, and angular fast Fourier transformation FFT in the frequency space. Targets are detected with a constant false alarm rate (CFAR) algorithm that clusters targets in a cluster algorithm Cluster. This generates coherent objects. These objects are tracked with a tracking algorithm Tracking. A function such as emergency braking can then be sent through an interface to control units and/or actuators in the vehicle.

A range/azimuth RA matrix is obtained from the distance FFT and subsequent angular FFT. The data format for the RA matrix can be the format for the input data x and/or output data \tilde{x} in the AI denoising.

A range/doppler RD matrix is obtained from the distance FFT and subsequent doppler FFT. The data format for the RD matrix can be the format for the input data x and/or output data \tilde{x} in the AI denoising.

A range/azimuth/doppler RAD matrix is obtained from the distance FFT, subsequent doppler FFT, and subsequent angular FFT. The data format for the RAD matrix can be the format for the input data x and/or output data \tilde{x} in the AI denoising.

The CFAR algorithm delivers point clouds. The data format for the point clouds can be the format for the input data x and/or output data \tilde{x} in the AI denoising.

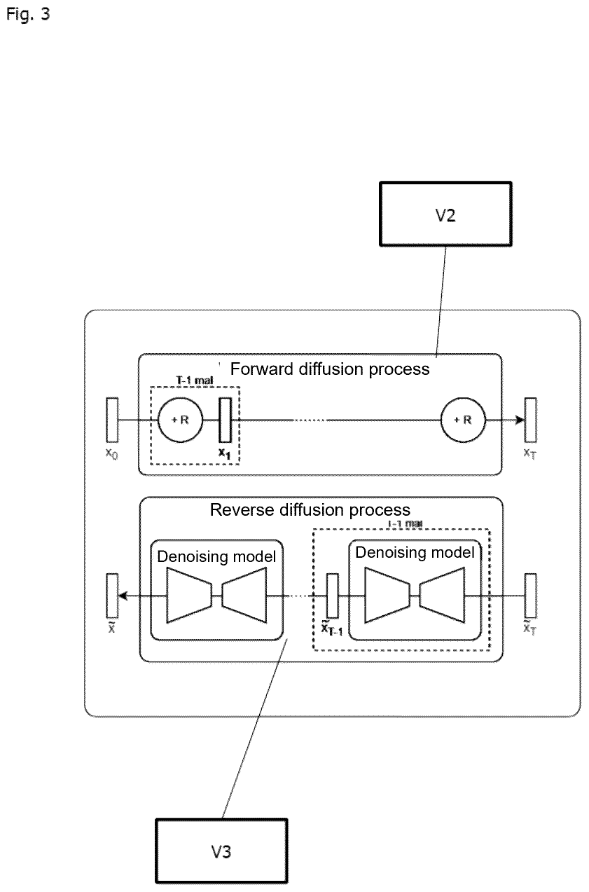

FIG. 3 shows the diffusion model. Training data x0 are input in a forward diffusion process. Noise R is added incrementally a number of times T in the forward diffusion process to obtain noisy training data xn, . . . , xT. This corresponds to step V2.

Noise is removed incrementally from the training data \tilde{x}₇, . . . , \tilde{x}₁ in a reverse diffusion process by the machine learning model. This corresponds to step V3. FIG. 3 shows the use of two machine learning models or denoising models, by way of example.

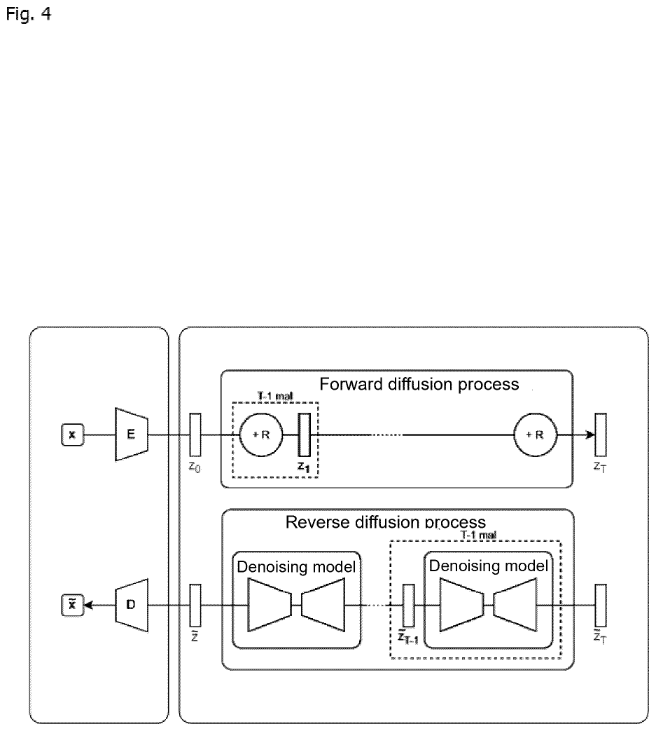

FIG. 4 shows the diffusion process shown in FIG. 3, in a latent space. An encoder E encodes the training data x0 into input data z0 without noise in the latent space, which are then processed by the diffusion model, as shown in FIG. 3. A decoder D then decodes the data \tilde{z} from the reverse diffusion process in the latent space back into the output data \tilde{x}.

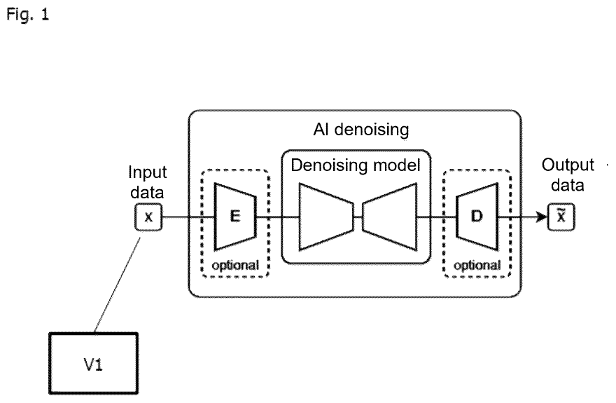

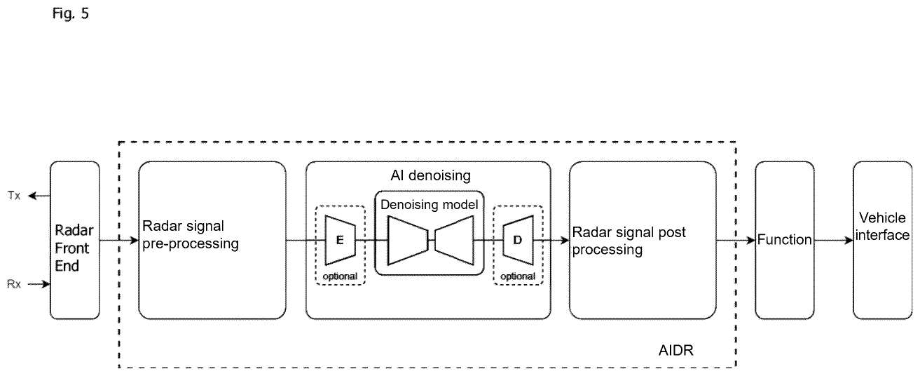

FIG. 5 shows the AI denoised radar AIDR as an independent system. The AI denoising shown in FIG. 1 is integrated here in a radar signal processing chain.

### REFERENCE SYMBOLS

V1-V3 steps
x₀ training data
x₁, . . . , x_{T} noisy training data
x data from the forward diffusion process, input data
\tilde{x} data from the reverse diffusion process, output data
z₀ input data without noise in the latent space
z₁, . . . , z_{T} noisy data in the latent space
\tilde{z} data from the reverse diffusion process in the latent space
R noise
E encoder
D decoder
Tx transmitting antenna
Rx receiving antenna
FFT fast Fourier transformation
CFAR constant false alarm rate algorithm
Cluster cluster algorithm
Tracking tracking algorithm
RA range/azimuth
RD range/doppler
RAD range/azimuth/doppler
AIDR AI-denoised radar

1. A computer-implemented method for removing noise from data through machine learning in radar data processing, comprising:
generating training data (x0) in at least one step in the radar data processing by recording predefined scenarios with at least one reference radar sensor, wherein there is less noise in the training data than in field data obtained in field recordings made with a field radar sensor;
processing the training data in a forward diffusion process in a diffusion model, wherein the forward diffusion process has a set number of diffusion steps, and obtaining noisy training data (x1, . . . , xT), to which noise (R) has been added incrementally; and
processing the noisy training data (x1, . . . , xT) in a reverse diffusion process in the diffusion model, wherein at least one machine learning model obtains a sample of the training data from a previous step in the diffusion process during the reverse diffusion process, learns to subtract the noise (R), and outputs a sample of the denoised training data,
wherein the machine learning model generates denoised data from the noisy data obtained from the radar data processing after a learning phase.

2. The method according to claim 1,
wherein:
highly reflective targets are placed in specific positions within a range of the radar in the predefined scenarios,
the predefined scenarios reproduce street traffic scenarios, in which disruptions are minimized along a test track, and/or
the predefined scenarios are recorded with reference radar sensors at different distances to the targets.

3. The method according to claim 1, wherein the reference radar sensors contain higher-quality components than the field radar sensors.

4. The method according to claim 1, wherein the reference radar sensor is a radar sensor model, and the predefined scenarios are simulated.

5. The method according to claim 1, wherein the radar data processing comprises:
a distance fast Fourier transformation of the data providing information regarding distances to targets,
a doppler fast Fourier transformation of the data providing information regarding speeds at which targets are approaching,
an angular fast Fourier transformation of the data providing information regarding angles to targets,
executing a constant false alarm rate algorithm to detect targets,
executing a clustering algorithm for cluster analysis of targets,
executing a tracking algorithm for tracking targets, and/or
determining a function,
and wherein the data obtained from one or more of the above processing steps are processed.

6. The method according to claim 5,
wherein the data formats:
for range/azimuth matrices obtained from distance Fourier transformations and subsequent angular Fourier transformations,
for range/doppler matrices obtained from distance Fourier transformations and subsequent doppler Fourier transformations,
for range/azimuth/doppler matrices obtained from sequential distance Fourier transformations, doppler Fourier transformations, and angular Fourier transformations, or
for point clouds obtained from executing the constant false alarm rate algorithm,
are processed by the diffusion model.

7. The method according to claim 1, wherein the training data are in a format they were in when they were input into the forward diffusion process, or some other format after the reverse diffusion process.

8. The method according to claim 1,
wherein the noise is:
distributed normally,
generated in a simulation, and/or
generated through use of different hardware components or settings.

9. The method according to claim 1,
wherein the training data are compressed through encoding, the encoded training data are processed by the diffusion model, and results from the reverse diffusion process are decoded.

10. The method according to claim 1,
wherein the machine learning model is used in all the steps of the reverse diffusion process, or different machine learning models are used in the steps of the reverse diffusion process.

11. A method for processing radar data,
wherein radar data are recorded by a radar sensor in the field, and
noise is removed from this data by the machine learning model that has been taught the method to claim in an intermediate step in the radar data processing, and the radar data is then input in a subsequent step in the radar data processing.

12. The method according to claim 11, comprising:
receiving at least one first radar data set for an environment recorded by at least one radar sensor, and at least one sensor data set for the environment recorded by at least one sensor;
determining at least one first actual scenario for the environment based on the sensor data set using selection artificial intelligence;
determining a radar function data set for a vehicle interface based on the first radar data set, the first actual scenario, and numerous predetermined processing steps executed on the first radar data set;
accessing numerous artificial intelligence models for numerous environment scenarios, wherein each AI model is designed to replace at least one processing step in a respective scenario;
replacing at least one of the processing steps in the radar function data set with an AI model using the selection AI when the first actual scenario conforms to at least one scenario in the AI model with a conformity value that is equal to or greater than a predetermined first conformity value; and
determining the radar function data set based on the numerous predetermined processing steps or an adjusted number of processing steps when the at least one processing step has been replaced by the first AI model,
wherein the denoising according to claim 11 takes place in an intermediate step in the above steps in the radar data processing.

13. A non-transitory computer readable medium having stored thereon a computer program for radar data processing containing commands with which hardware executes the method according to claim 11, when the program has been installed on the hardware or is executed by such.

14. A radar sensor for recording a vehicle's environment, wherein the radar sensor contains a hardware component designed to upload or execute the computer program according to claim 13, and remove noise from radar data recorded by the radar sensor.
